(19) United States
(12) Patent Application Publication
(10) Pub. No.: US 2024/0324525 A1
(43) Pub. Date: Oct. 3, 2024

(54) MODIFIED DRIP IRRIGATION METHOD

(71) Applicant: KING FAISAL UNIVERSITY, Al-Ahsa (SA)

(72) Inventors: FAISAL IBRAHIM ZEINELDIN, AL AHSA (SA); KHALID GUMA BIRO TURK, AL-AHSA (SA)

(21) Appl. No.: 18/593,479

(22) Filed: Mar. 1, 2024

Related U.S. Application Data
(63) Continuation-in-part of application No. 18/191,363, filed on Mar. 28, 2023, now abandoned.

(51) Int. Cl. A01G 25/06; A01G 25/02

(52) U.S. Cl. CPC A01G 25/06; A01G 25/023

(57) ABSTRACT

A modified drip irrigation (M-DI) system includes a water source, at least one drip line, and one pipe supporting one drip line horizontally along an upper edge of a ridge. In an embodiment, the at least one pipe includes a first plurality of slanted openings defined along a first portion of a pipe wall and a second plurality of slanted openings aligned with the first plurality of openings and defined along a second, opposing portion of the pipe wall.

This application is a continuation-in-part of U.S. application Ser. No. 18/191,363, filed Mar. 28, 2023, the entire contents of which are incorporated herein by reference.

### BACKGROUND

### 1. Field

The disclosure of the present patent application relates to agricultural irrigation methods, particularly a drip irrigation method for simultaneously irrigating two plant lines.

### 2. Description of the Related Art

Drip irrigation has become increasingly popular in recent years because of the increasing water shortage in many areas. Drip irrigation, as the name implies, applies tiny quantities of water more or less continuously to the soil being irrigated, in contrast to the more conventional ditch-type irrigation methods in which ditches are arranged along rows of plants to be watered and periodically flooded to feed the roots of plants adjacent to the ditches. Drip irrigation is particularly effective when it is applied below the soil, as much smaller quantities of water can be utilized for irrigating the same amount of land because evaporation is minimized. This is particularly important in arid areas where evaporation takes place rapidly. In addition, because there is an absence of evaporation, salt deposits do not accumulate in the areas adjacent to the root structure of the plants being irrigated, which problem necessitated, in the past, periodic flushing in order to remove the salt deposits.

As stated above, water is applied in minimal quantities in drip irrigation more or less continuously. In this manner, the soil is continuously kept in a “substantially moist” condition so that water is constantly available for the roots of plants being irrigated. This is so even the surface appearance may look dry. One advantage of drip irrigation over the more conventional ditch-type irrigation is that the soil adjacent to plants is more or less continuously dry on the surface. Therefore, the planter or farmer can operate heavy-duty servicing equipment such as sprayers along the rows of the plants without being mired in mud or without having to follow a particular schedule between the times when those areas would ordinarily be flooded in ditch irrigation. Furthermore, with this comparatively dry soil condition adjacent to plants, manual pickers can go along the plants without the usual difficulties associated with muddy soil conditions.

A variety of methods and apparatus have been utilized by drip irrigation, including porous wall tubing with the water outlets being located throughout the entire hose wall for continuous wetting, as long as the hose is supplied with water. Other developments include various valves or water emitters placed sequentially in spaced apart relation along the supply tube or hose, with these valves being arranged to emit water to the soil while simultaneously providing for anti-clogging of the valve orifice from dirt particles adjacent to the orifice.

Although subsurface drip irrigation (DI) is an efficient water-saving method, a significant amount of irrigation water and fertilizer is wasted when using it on homogenous sandy soil profiles.

Thus, a modified surface drip irrigation method that provides subsurface irrigation is desired to solve the problems mentioned above.

### SUMMARY

A modified surface drip irrigation (M-DI) system includes a water source, at least one drip line, and at least one pipe supporting the at least one drip line in a horizontal position along an upper edge of a ridge. In an embodiment, the pipe includes a first plurality of slanted openings defined along a first portion of a pipe wall and a second plurality of slanted openings aligned with the first plurality of openings and defined along a second, opposing portion of the pipe wall.

A modified drip irrigation method includes:
defining a groove within a land area,
providing a clay layer within the groove,
positioning at least one pipe upright within the groove, and
disposing of a drip line horizontally over the opening of at least one pipe.
   The pipe's rim supports a portion of the drip line with an emitter, providing water to the pipe from the drip line. Then the pipe supplies water to the soil along opposing sides of the pipe through the first and second plurality of second openings. In an embodiment, at least one pipe comprises a plurality of pipes aligned along the drip line length.

With the present method, water flowing from the drip line is freely discharged as irrigation water into the at least one pipe, which distributes soil water horizontally in opposing directions. The water can thereby be distributed into the soil horizontally more than vertically.

These and other features of the present subject matter will become readily apparent upon further review of the following specification.

### BRIEF DESCRIPTION OF THE DRAWINGS

FIG. 1 is a perspective view of a pipe according to the present teachings.

FIG. 2 is a perspective view of a plurality of pipes wrapped in cloth, aligned in a groove and supporting a drip line thereon.

FIG. 3 is a right side perspective view of a PVC pipe with a plurality of 45° slanted rectangular openings and a joint diagram of their associated water flow.

FIG. 4 is an overview of a PVC pipe cross section

FIG. 5 is a detailed diagram showing a single 45° slanted rectangular opening

FIG. 6 is a diagram of cross section of a PVC pipe as inserted into a groove comprised of sand soil and clay soil layers

FIG. 7 is a diagram of a linear arrangement of PVC pipes partially installed in a clay layer in a groove of a land area of homogenous sandy soil profile.

FIG. 8 is an overview of one drip line and a plurality of PVC pipes with 45° slanted rectangular openings in accordance with the modified drip irrigation method that delivers subsurface irrigation water to root systems for two rows of tomato plants.

FIG. 9 is a graph comparing the greenhouse tomato fruit yield between the modified drip irrigation system of the present teachings and a conventional drip irrigation system.

### DETAILED DESCRIPTION OF THE PREFERRED EMBODIMENTS

The following definitions are provided to understand the present subject matter and constrain the appended patent claims.

Throughout the application, where compositions are described as having, including, or comprising specific components, or where processes are described as having, including, or comprising specific process steps, it is contemplated that compositions of the present teachings can also consist essentially of, or consist of, the recited components and that the processes of the present teachings can also consist essentially of, or consist of, the recited process steps.

It is noted that, as used in this specification and the appended claims, the singular forms “a”, “an”, and “the” include plural references unless the context dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, elements and/or features of a composition or a method described herein can be combined in various ways without departing from the spirit and scope of the present teachings, whether explicit or implicit.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the term “about” is before a quantitative value, the present teachings also include the specific quantitative value, unless specifically stated otherwise. As used herein, “about” refers to a ±10% variation from the nominal value unless otherwise indicated or inferred.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range. The described subject matter encompasses any other stated or intervening value in that range. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims are to be understood as being modified in all instances by the term “about”. Accordingly, unless indicated to the contrary, the numerical parameters outlined in the following specification and attached claims are approximations that may vary depending upon the desired properties sought to be obtained. At the very least, each numerical parameter should be construed in light of the number of reported significant digits and by applying ordinary rounding techniques.

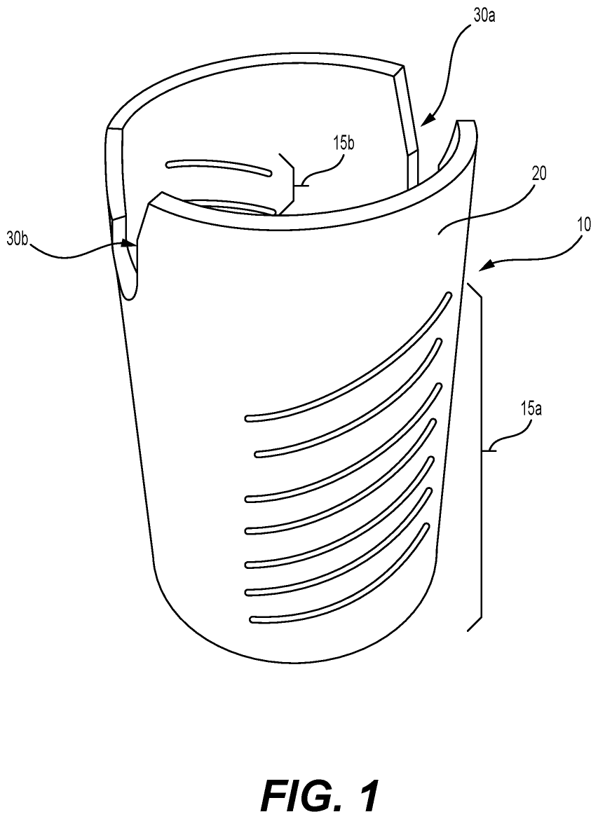

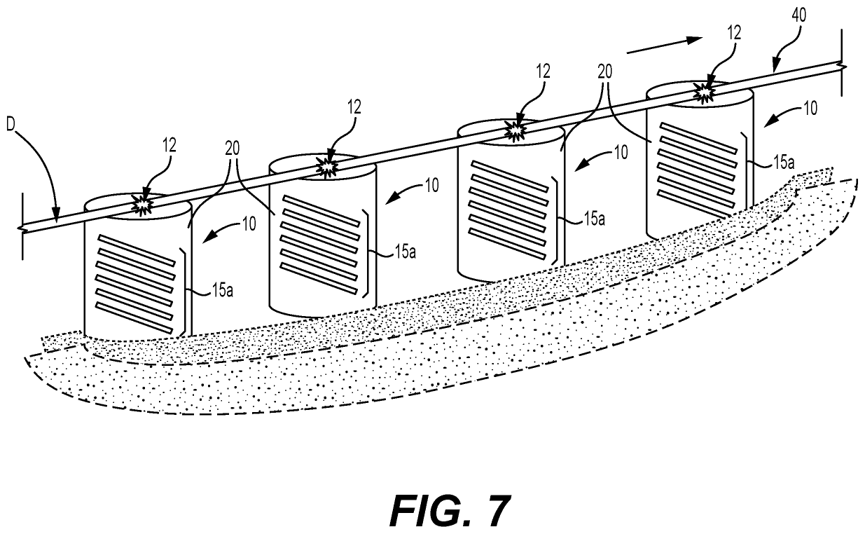

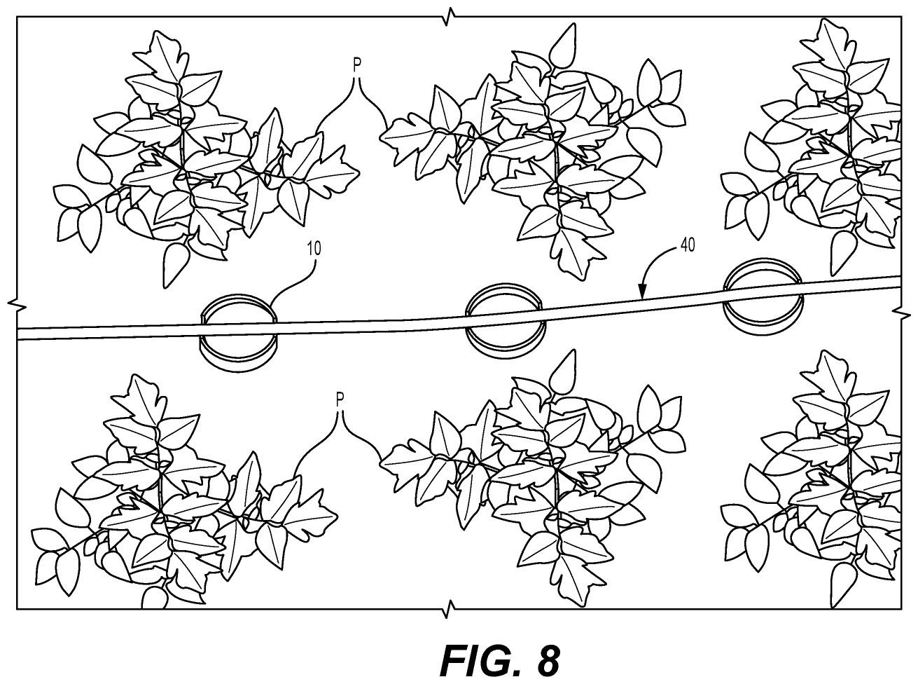

As shown in FIGS. 1-8 a modified drip irrigation (M-DI) system includes at least one drip line (in-line dripper) 40 connected to a water source D and at least one pipe 10 for supporting the drip line 40 in a horizontal position along an upper edge thereof. In an embodiment, at least one pipe 10 includes a first plurality of openings 15a defined along a first portion of a pipe wall 20 and a second plurality of openings 15b aligned with the first plurality of openings 15a and defined along a second, opposing portion the pipe wall 20. In an embodiment, the first plurality of openings 15a and the second plurality of openings 15b are generally rectangular, slanted openings. In an embodiment, pipe 10 is about 15 cm long and has a diameter of about 10.2 cm. In an embodiment, opposing portions of a rim of the pipe can include first and second notches 30a, 30b for supporting the drip line 40 in a horizontal position over a pipe opening.

A modified drip irrigation method includes defining a groove within a land area, providing a clay layer within the groove, positioning at least one pipe upright within the groove, disposing a drip line horizontally over the opening of at least one pipe such that the drip line is secured within rim notches of the at least one pipe, providing water to the drip line, receiving water in the pipe from the drip line, and supplying water to soil situated along opposing sides of the pipe through the first and second plurality of openings.

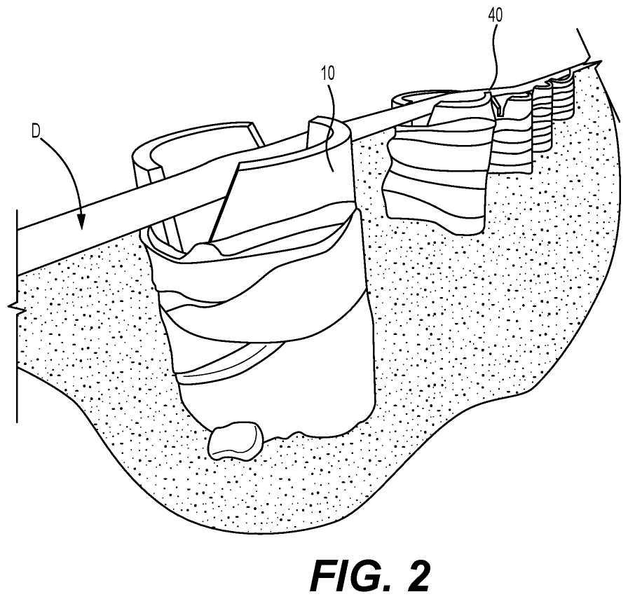

In an embodiment as shown in FIGS. 2, and 7-8, at least one pipe 10 can include a plurality of pipes aligned in a row. In an embodiment, a line of plants or a plant line P can be planted along opposing sides of the plurality of pipes 10, for example, along a length of the drip line 40. In the present method, water flowing out of the drip line is freely discharged as irrigation water into at least one pipe, which distributes soil water horizontally more than vertically into the soil and towards the plant roots.

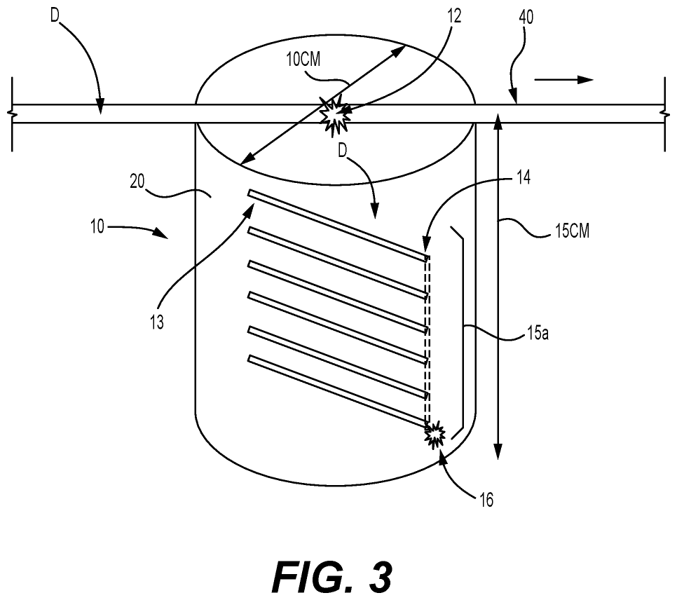

According to an embodiment, the pipe comprises polyvinyl chloride (PVC). The diameter of the pipe can range from about 8 cm to about 11 cm, for example, about 8 cm, about 9 cm, about 10 cm, or about 11 cm. The length of the pipe can range from about 11 cm to about 17 cm, for example, about 11 cm, about, 12 cm, about 13 cm, about 14 cm, about 15 cm, about 16 cm, or about 17 cm. The pipe is 15 cm long and 10.2 cm in diameter in a particular embodiment. Soil within the PVC pipe 10 moves through the saturated mixture medium towards the rectangular slanted openings by Darcy's law (Hydraulic gradient). This mixture medium intended to have lower saturated hydraulic conductivity (Ksat) and higher water retention capacity as compared to the PVC pipe surrounding sandy soils (Predominately coarse-textured soils in soil profiles). Saturation of the mixture medium inside the PVC pipe 10 resumes at the top because the discharge of the emitter 12 as in FIGS. 3 and 6-7. As shown in FIGS. 3 and 5, when soil water reaches the upper end 13 of the slanted rectangular opening 15a at the wall of the PVC pipe 10, then water flows across the thickness wall due to kinetic energy rather than by Darcy's law of the pipe (3 mm) to lower end 14 of the opening.

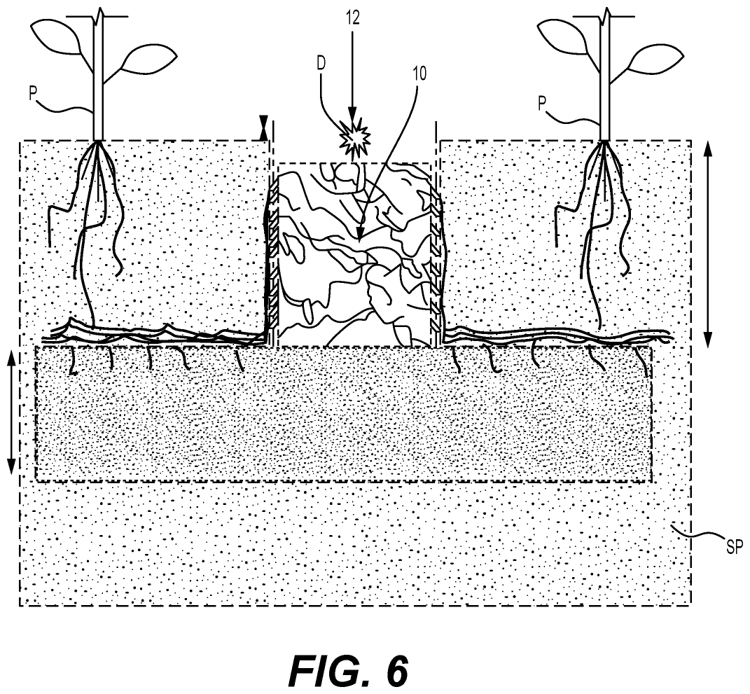

As the saturation of the mixture medium proceeds from the upper end 13 to the lower end 14 of the PVC pipe 10, more water flows by kinetic energy along the rectangular slanted openings 15a across thickness of the pipe wall to the bottom of pipe as shown in FIGS. 3-5. Therefore, design of rectangular slanted openings with a 45° declination angles from their respective upper ends 13 to their respective lower ends 14 are specifically chosen with purpose of developing the kinetic energy flow across wall thickness of the PVC pipes 10. And this in turn enables the openings 15a to be self-cleaning and resistant to clogging by debris and sand particles. Then the water flow from all the lower ends 14 of the rectangular slanted openings join at a point outside 16 the PVC pipe 10, in the soil, facing the lower end of the lowest slanted opening as shown FIG. 3. This point at depth of 10 cm from soil surface, on the clay layer, becomes more saturated with the irrigation process, and then horizontally distributes soil water effectively towards the root system of the vegetable plant P as shown in FIG. 6. Therefore, this saturated point 16, which formed above the clay layer; it will act like subsurface emitter. As a result, soil moisture from this statured site moves horizontally in sandy layer more than vertically in the clay, towards root system of a vegetable plant P. Similarly, this occur on the opposite side of the PVC pipe, horizontally.

Accordingly, the significant of the rectangular 45° slanted openings can be summarized in the following steps. First, their sloped design make them to develop fast soil water flow a cross wall thickness of the PVC pipes 10 from their upper ends 13 to their lower ends 14 due to the kinetic energy and gravitational force. Second, due to the developed fast water flow, the rectangular slanted openings 15a undergo a self-cleaning from debris and clogging. And finally, because of a development of two subsurface saturated sites 16 surrounding a PVC pipe 10, the rectangular 45° slanted openings act like two subsurface emitters, above the clay soil layer, and horizontally deliver soil moisture to root systems of two vegetable plants P.

In an embodiment, the clay soil layer can have a thickness of about 6 cm to about 9 cm, for example, about 6 cm, about 7 cm, about 8 cm, or about 9 cm. In an embodiment, the clay soil layer can have a width of about 35 cm to about 43 cm, for example, about 35 cm, about 36 cm, about 37 cm, about 38 cm, about 39 cm, about 40 cm, about 41 cm, about 42 cm, or about 43 cm. In an embodiment, the clay soil layer can be spaced about 15 to about 18 cm from the soil surface, for example, about 15 cm, about 16 cm, about 17 cm, or about 18 cm. In a specific embodiment, the clay soil layer can be spaced about 17.5 cm from the soil surface; the clay soil layer can be about 7.5 cm thick and 40 cm wide.

The sub-surface drip irrigation of land described herein can be directed at opposing land directions. Water D, provided to the water line or drip line 40, is directed to opposing, horizontal positions within the soil in predetermined measured quantities through the pipes. Each increment of water supplied to the land area may be substantially equal, regardless of how close the source of water supply is to the position from which water is supplied. In this manner, water can be simultaneously supplied horizontally to the root zone of two parallel plant lines in a land area. In an embodiment, the land area is a ridge or a land portion that is elevated with respect to adjacent land portions.

In an embodiment, the land area is within a greenhouse. As shown in FIGS. 1 and 6, the land area can include primarily sandy soil SP. A clay layer can be disposed of within the sandy soil SP, and a bottom portion of pipe 10 can be secured within the clay layer. When the dripper above the pipe drips water in pipe 10, the water flows through the openings 15a, 15b primarily horizontally toward the roots of plants P, on the left and the right side of the pipe. As a result, less water flows down into the sandy soil beneath the clay layer as shown in FIG. 6.

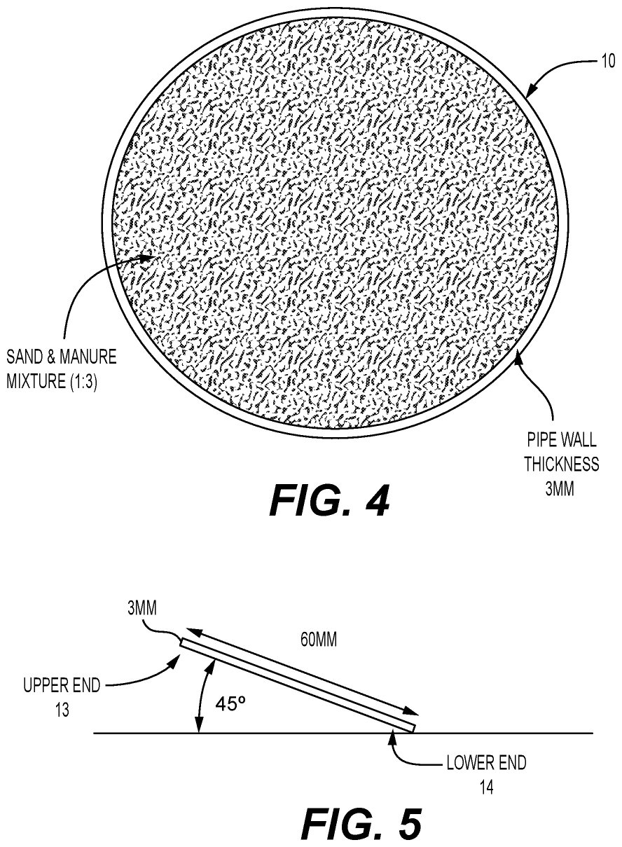

In an embodiment, positioning at least one pipe 10 upright within the groove can include securing a bottom portion of the pipe within the clay layer, for example, positioning the pipe about 2 cm to about 4 cm into the clay layer. In an embodiment, the bottom portion of the pipe may be disposed of about 2.5 cm into the clay layer. After positioning the bottom portion of the pipe within the clay layer, the groove area surrounding the pipe can be refilled with soil, exposing the pipe's rim. The groove can be filled with manure and sandy soil in an embodiment as shown in FIG. 4. In an embodiment, a ratio of the mixture of sand to manure can be about 1:3. The drip line 40 can be positioned within the notches 30a, 30b of the pipe 10.

In an embodiment as shown in FIGS. 2 and 7-8, a plurality of grooves are formed, and a plurality of pipes 10 are aligned within each groove corresponding to a ridge or elevated land portion. Drip lines 40 are provided over the plurality of pipes. Dripping irrigation water from the inline drippers can provide irrigation water to the root portions of plants growing along opposing sides of the pipe within the ridge.

With the modified surface drip irrigation method, water can be used more effectively for agricultural irrigation than conventional irrigation. As a result, the modified drip surface irrigation (M-DI) method can be more cost-effective than conventional surface and subsurface drip irrigation methods. In addition, drippers of the (M-DI) are easier to maintain than conventional subsurface drip irrigation methods as they are positioned under the soil and, as such, are not prone to soil blockage.

Further, as the modified surface drip irrigation method distributes water beneath the soil surface, sewage water, e.g., tertiary treated sewage water, may irrigate plants in a land area without contacting the soil surface. In this respect, the (M-DI) can be more hygienic than the conventional surface drip irrigation methods.

The following examples illustrate the present teachings.

### Example 1

### Greenhouse Modified Surface Drip Irrigation (M-DI)

A modified surface drip irrigation (M-DI) method was provided within a low-tech greenhouse dominated with a homogenous sandy soil profile. Ridges were formed in the land area of the greenhouse, and grooves, 17.5 cm deep, were defined within the ridges. A clay soil layer was disposed of with the grooves, and PVC pipes with slanted sidewall openings were wrapped with a permeable cloth and inserted 2.5 cm into the clay layer. The clay soil layer was 7.5 cm thick and 40 cm wide. Drippers were positioned on each PVC pipe to provide water to the soil through the opposing slanted openings. One dripline lateral of the M-DI irrigated two rows of tomato plants, one on the right and the other on the left of the pipes.

A second set of ridges was formed to support a conventional surface drip irrigation (DI) system. Two dripline laterals were placed on each of the second group of ridges. The second group of ridges did not include a clay layer or PVC pipes with openings. Each dripper irrigated only one vegetable plant.

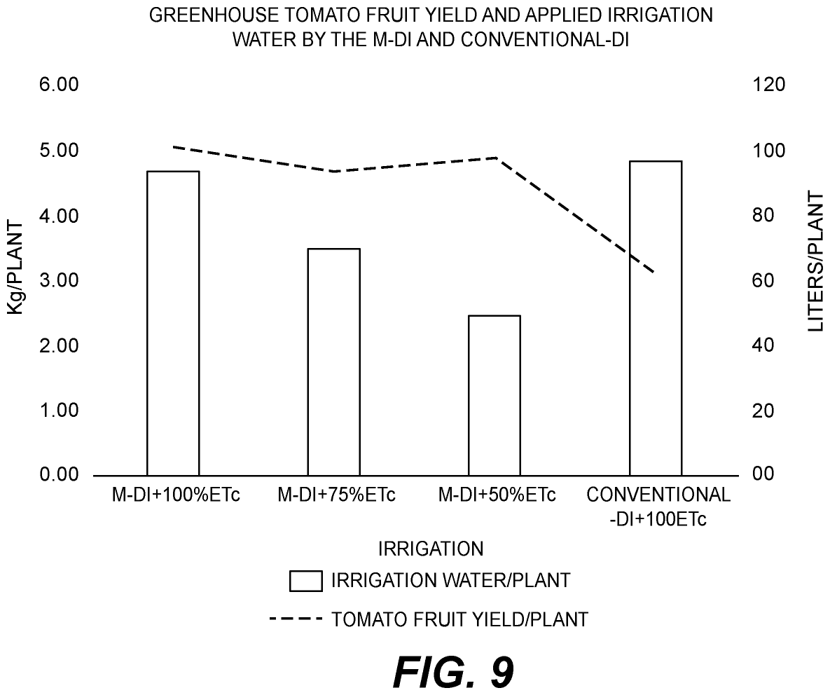

A factorial analysis (P=0.05) showed significant differences in soil moisture at 5 cm soil depth between the M-DI and DI irrigation methods. The results of the analysis are provided in the Table below and illustrated in FIG. 9

TABLE

| Source | DF | SS | MS | F | P |
|---|---|---|---|---|---|
| Rep | 2 | 0.00681 | 0.00341 | | |
| M-DI, DI | 1 | 0.12132 | 0.12132 | 37.52 | 0 |
| T | 9 | 1.59224 | 0.17692 | 54.71 | 0 |
| ETc | 3 | 0.08635 | 0.02878 | 8.9 | 0 |
| M-DI, DI*T | 9 | 0.07951 | 0.00883 | 2.73 | 0.0055 |
| M-DI, DI*ETc | 3 | 0.08264 | 0.02755 | 8.52 | 0 |
| T*ETc | 27 | 0.54878 | 0.02033 | 6.29 | 0 |
| M-DI, DI*ETc*T C | 27 | 0.06493 | 0.0024 | 0.74 | 0.8153 |
| Error | 158 | 0.51093 | 0.00323 | | |
| Total | 239 | 3.09351 | | | |

M-DI = Modified surface drip irrigation (our invention)
DI = Conventional surface drip irrigation
T = Growing time
ETc = Irrigation regime

It is to be understood that the modified surface drip irrigation method is not limited to the specific embodiments described above but encompasses any and all embodiments within the scope of the generic language of the following claims enabled by the embodiments described herein or otherwise shown in the drawings or described above in terms sufficient to enable one of ordinary skill in the art to make and use the claimed subject matter.

We claim:

1. A modified surface drip irrigation system, comprising:
at least one lateral drip line connected to a water source;
at least one pipe for supporting the drip line in a horizontal position, the pipe including a cylindrical wall, a central opening, a pair of notches formed along a rim of an upper edge of the cylindrical wall, a first plurality of slanted rectangular openings defined along a first portion of the cylindrical wall and a second plurality of slanted rectangular openings defined along a second, opposing portion of the cylindrical wall.

2. The modified surface drip irrigation system of claim 1, wherein at least one pipe comprises a plurality of pipes and at least one drip line comprises a plurality of drip lines.

3. The modified surface drip irrigation system of claim 1, wherein the at least one pipe is formed from polyvinyl chloride.

4. The modified surface drip irrigation system of claim 1, wherein a diameter of the at least one pipe ranges from about 8 cm to about 11 cm, and a length of the at least one pipe ranges from about 11 cm to about 17 cm

5. The modified surface drip irrigation system of claim 1, wherein a diameter of the at least one pipe ranges from about 8 cm to about 11 cm, a length of the at least one pipe ranges from about 15 cm to about 17 cm, and a thickness of the at least one pipe ranges from about 3 mm to about 4 mm.

6. A method of using the modified surface drip irrigation system of claim 1, comprising:
defining a groove within a land area, wherein the land area further comprises a homogenous coarse-textured sandy soil profile;
providing at least one of a fine-textured clay soil layer, a natural clay liquid layer, or biochar layer within the groove;
positioning the at least one pipe upright within the groove and partially within the at least one of a clay soil layer, a natural clay liquid layer, or a biochar layer;
disposing the at least one drip line horizontally over the central opening of the at least one pipe by positioning the at least one drip line within the notches;
providing water to the at least one drip line;
receiving water in the at least one pipe from an emitter of the at least one drip line;
supplying water to a soil mixture of sand and manure wherein said soil mixture has a water retention capacity and becomes saturated, situated adjacent the at least one pipe,
wherein more of the soil water of the saturated soil mixture moves through the slanted rectangular openings into the surrounding sandy soil layer, said surrounding sandy soil layer having a higher saturated conductivity (Kₛₐₜ), than vertically into the clay soil layer, said clay soil layer having a lower saturated hydraulic conductivity (Kₛₐₜ),
wherein the soil water of the saturated soil mixture moves faster along a wall thickness of the pipe by an acquisition of kinetic energy from upper ends of the slanted rectangular openings to lower ends of the slanted rectangular openings of a first and a second plurality of the at least one pipe; and
forming saturated sites of combined soil water and slanted rectangular openings of said first plurality and said second plurality of the at least one pipe in the surrounding sandy soil layer immediately above said clay soil layer.

7. The method of claim 6, wherein the at least one pipe comprises a plurality of pipes aligned in a row and the at least one drip line with emitters comprises a plurality of drip lines positioned over the plurality of pipes.

8. The method of claim 7, wherein the method further comprises:
providing soil water to a plant line along opposing sides of the plurality of pipes, whereby roots of the plant line are vertically situated from the first and second plurality of slated rectangular openings;
distributing the more of combined soil water of the saturated sites of the first plurality and the second plurality of slanted rectangular openings horizontally into the coarse textured sandy soil layer than vertically into the fine textured clay soil layer; and
providing soil water and nutrients to an effective root depth of a vegetable plant root systems lines along opposing sides of the plurality of pipes.

9. The method of claim 8, wherein the clay soil layer has a thickness ranging from about 6 cm to about 9 cm and a width ranging from about 35 cm to about 43 cm, and
wherein the sandy soil layer surrounding the at least one pipe has a thickness ranging from about 10 cm to about 15 cm and equal width and length ranging from about 35 cm to about 43 cm.

10. The method of claim 9, wherein the clay layer is spaced about 15 cm to about 18 cm from the soil surface, and wherein the sandy soil layer is situated surrounding the at least one pipe and above clay soil layer to a soil surface.

11. A modified surface drip irrigation method, comprising:
defining a groove within a land area, wherein the land area further comprises a homogenous coarse-textured sandy soil profile;
providing at least one of a fine-textured clay soil layer or implementing a soil conditioner wherein the soil condition is a natural clay liquid or biochar within the groove to improve hydraulic properties of the coarse textured sandy soil by decreasing saturated conductivity (Kₛₐₜ) and increasing a water retention capacity;
positioning a plurality of pipes upright within the groove, each of said plurality of pipes including a cylindrical wall, a central opening, and a pair of notches formed along a rim of an upper edge of the cylindrical wall;
defining a first plurality of slanted rectangular openings along a first portion of the cylindrical wall, and a second plurality of slanted rectangular openings defined along a second opposing portion of the cylindrical wall;
disposing the at least one drip line horizontally over the central opening of each of the plurality of pipes by positioning the at least one drip line within the notches;
providing water to the at least one drip line;
receiving water in the plurality of pipes from at least one drip line; and
supplying water to soil situated along opposing sides of the plurality of pipes through the first plurality and the second plurality of slanted rectangular openings.

12. The method of claim 11, wherein a diameter of each of the plurality of pipes ranges from about 8 cm to about 11 cm, and a length of each of the plurality of pipes ranges from about 11 cm to about 17 cm.

13. The method of claim 11, wherein the method further comprises:
providing a vegetable plant line along opposing sides of the plurality of pipes, whereby roots of the plant line are vertically situated from the first and second plurality of slanted rectangular openings; and
receiving water flowing from the first plurality and the second plurality of slanted rectangular openings to saturates sites and distributing horizontally from sites of high hydraulic potential to low hydraulic potential within a vicinity of a plant root system.

14. The method of claim 11, wherein the clay layer has a thickness ranging from about 6 cm to about 9 cm and a width ranging from about 35 cm to about 43 cm.

15. The method of claim 11, wherein the clay layer is spaced about 15 cm to 18 cm from the soil surface

16. The method of claim 11, wherein each of the plurality of pipes is formed from polyvinyl chloride.
